(19) United States
(12) Patent Application Publication
(10) Pub. No.: US 2006/0065542 A1
(43) Pub. Date: Mar. 30, 2006

(54) Synthesis of hydrogen peroxide

(76) Inventors: Laszlo T. Nemeth, Barrington, IL (US); Anil R. Oroskar, Oakbrook, IL (US); Santi Kulprathipanja, Inverness, IL (US); Gavin P. Towler, Barrington, IL (US); Kurt M. Vanden Bussche, Lake in the Hills, IL (US)

Correspondence Address: JOHN G TOLOMEI, PATENT DEPARTMENT;UOP LLC, 25 EAST ALGONQUIN ROAD, P O BOX 5017, DES PLAINES, IL, 60017-5017, US

(21) Appl. No.: 10/955,442

(22) Filed: Sep. 30, 2004

(51) Int. Cl. C01B 15/023; C25B 9/00; C25B 1/28

(52) U.S. Cl. 205/471; 423/588; 204/242

(57) ABSTRACT

An apparatus and process for producing hydrogen peroxide on an as-needed basis is disclosed. An oxidizing agent is generated for reaction with water to generate hydrogen peroxide.

### FIELD OF THE INVENTION

This invention relates to the production of hydrogen peroxide. Specifically, the production of hydrogen peroxide in an acidic solution, and the subsequent separation and recycle of the acid from the hydrogen peroxide.

### BACKGROUND OF THE INVENTION

Currently the most widely practiced industrial scale production method for hydrogen peroxide is an indirect reaction of hydrogen and oxygen employing alkylanthraquinone as the working material. In a first catalytic hydrogenation step, the alkylanthraquinone, dissolved in a working solution comprising organic solvents (e.g. di-isobutylcarbinol and methyl naphthalene), is converted to alkylanthrahydroquinone. In a separate autooxidation step, this reduced compound is oxidized to regenerate the alkylanthraquinone and yield hydrogen peroxide. Subsequent separation by aqueous extraction, refining, and concentration operations are then employed to give a merchant grade product. In order to be economical, the alkylanthraquinone process requires large scale production of hydrogen peroxide to justify the cost of the subsequent extraction and purification of the hydrogen peroxide.

The direct production of hydrogen peroxide from hydrogen and oxygen is one route to produce hydrogen peroxide without the costly separation and purification associated with the alkylanthraquinone process. However, there are problems associated with this, such as working with combustible mixtures of hydrogen and oxygen in the gas phase, and the low solubility of hydrogen and oxygen at relatively low pressures in water.

It would be convenient and a savings to be able to produce hydrogen peroxide without the complex processes associated with large scale production, or using processes that require continuous addition of chemicals which would require storage and careful handling. In addition, a simpler process that would enable economic production of hydrogen peroxide on a small scale and the periodic production of hydrogen peroxide on an as needed basis can provide for usage of hydrogen peroxide in areas where it would otherwise be inconvenient, such as home usage, foregoing the need to buy and store hydrogen peroxide.

### SUMMARY OF THE INVENTION

The present invention provides a method and apparatus for the production of hydrogen peroxide. The production can be in small or large quantities, but the invention is aimed at the periodic production of hydrogen peroxide for intermittent use. The invention comprises an electrolyzer for generating a strong oxidizing agent from an oxidizable compound. The oxidizing agent is passed to a hydrolyzer where the oxidizing agent oxidizes water to generate an intermediate stream comprising hydrogen peroxide. The intermediate stream is separated and generates a product stream comprising hydrogen peroxide and a recycle stream comprising the oxidizable compound. In a preferred embodiment, the oxidizable compound is a strong acid.

Another aspect of the invention comprises the process of oxidizing a sulfate compound to generate a persulfate in an electrolyzer, generating a persulfate stream. The persulfate stream is hydrolyzed with water in a hydrolyzer to generate an intermediate stream comprising hydrogen peroxide and the sulfate compound. The intermediate stream is separated to generate a product stream comprising hydrogen peroxide and a recycle stream comprising the sulfate compound.

In a specific embodiment, the invention comprises an electrolyzer for oxidizing sulfuric acid to generate an electrolyzer outlet solution comprising persulfuric acid. The outlet solution is passed to a hydrolyzer with water, and operated at conditions to oxidize the water to hydrogen peroxide and reduce the persulfuric acid to sulfuric acid. An intermediate stream comprising hydrogen peroxide and sulfuric acid is passed to an adsorption separation unit. The adsorption separation unit separates the hydrogen peroxide from the sulfuric acid, and generates a product stream comprising hydrogen peroxide which is passed to a product storage unit. The adsorption separation unit also generates a recycle stream comprising sulfuric acid and returns the sulfuric acid to the electrolyzer. This process minimizes the need to intermittently add chemicals to form the oxidizing agent in the electrolyzer.

In another embodiment, the invention is as above, except for the separation unit. The hydrolyzer passes the intermediate solution comprising hydrogen peroxide and sulfuric acid to an air stripping unit. The air stripping unit separates the hydrogen peroxide from the intermediate solution by passing air through the solution and creating a vapor comprising hydrogen peroxide, steam and air. The vapor is condensed and a product stream comprising hydrogen peroxide is passed to a product storage unit. The air stripping unit also generates a recycle stream comprising sulfuric acid which is returned to the electrolyzer.

Other objects, advantages and applications of the present invention will become apparent to those skilled in the art from the following drawings and detailed description.

### BRIEF DESCRIPTION OF THE DRAWINGS

FIG. 1 is a diagram of the process;

FIG. 2 is a diagram of an alternate embodiment of the process;

FIG. 3 is a plot of hydrogen peroxide yields and persulfate conversion as a function of time in a hydrolyser at 60° C.;

FIG. 4 is a plot of hydrogen peroxide yields and persulfate conversion as a function of time in a hydrolyser at 70° C.;

FIG. 5 is plot of hydrogen peroxide concentration and pH as a function of effluent volume in a test case;

FIG. 6 is a plot of hydrogen peroxide concentration and sulfuric acid concentration as a function of effluent volume in a second test case;

FIG. 7 is a logarithmic plot of the hydrogen peroxide and sulfuric acid, with a plot of the pH of the effluent as a function of the effluent volume in the second test case.

### DETAILED DESCRIPTION OF THE INVENTION

The synthesis of hydrogen peroxide in an aqueous solution that is relatively free from other chemical reactants is important for many applications. For example, bleaching and sanitizing using hydrogen peroxide is very useful if there are no added chemicals in the hydrogen peroxide solution that need special handling to dispose of. Therefore it would be very useful to be able to form hydrogen peroxide with a method that allows for relatively easy recovery of any chemicals used in the production of the hydrogen peroxide, or for the synthesis of an additive free aqueous hydrogen peroxide solution. Examples of uses of hydrogen peroxide include bleaching in washing machines, sanitizing in spas, dishwashers, pools, hot tubs, faucets, garbage disposals, air conditioners, refrigerators, freezers, humidifiers, dehumidifiers, toilets, urinals, bidets, agricultural equipment, and food processing equipment. Hydrogen peroxide in a gas phase can also be used in dryers and for air sanitation. Positioning of the hydrogen peroxide generation unit in the appliance and the outlet for admitting hydrogen peroxide to the appliance is subject to determinations for optimal hydrogen peroxide effectiveness.

The production of hydrogen peroxide requires a strong oxidizing agent, and strong oxidizing agents can be produced electrochemically. Inorganic persulfate compounds are very strong oxidants, and the preferred oxidants of the present invention. Other strong oxidizing agents include perchlorate compounds, and perchloric acid. While other oxidizing agents are contemplated, persulfuric acid is used as an exemplary example and not intended to limit the choice of oxidizing agents. Currently, the commercial method of producing persulfate compounds, such as peroxydisulfuric acid (or persulfuric acid), is through an electrochemical process. The operating conditions of the electrochemical reactor for the production of persulfuric acid are different from the conditions for using the acid to oxidize water to hydrogen peroxide. Therefore, the persulfuric acid solution is transferred to a second unit for reacting the acid to generate the hydrogen peroxide. The second unit generates a solution with the desired product, hydrogen peroxide, but also includes an undesired component, sulfuric acid. The generated solution must be separated to produce a desired product, the hydrogen peroxide, without the undesired component, but also to recover the sulfuric acid to reuse and limit the need for additives to generate the hydrogen peroxide.

While the present invention has as its preferred embodiment the generation of hydrogen peroxide the process is intended to include other oxidizing compounds. A solution of hydrogen peroxide may also comprise intermediate compounds related to the production of hydrogen peroxide. The intermediate compounds are also oxidizing compounds that may be present in a hydrogen peroxide solution. These intermediate compounds include, but are not limited to, perhydroxyl ions, perhydroxyl radicals, hydroxyl radicals, and peroxide ions. When discussing solutions comprising hydrogen peroxide, it is intended to include solutions comprising any of one or more intermediate compounds that may be formed during the hydrogen peroxide production.

While most hydrogen peroxide is produced on a large scale with a complex chemical process, hydrogen peroxide is not conveniently stored for individual, small scale use. Therefore, an alternative means of forming hydrogen peroxide on a small scale is to form the peroxide directly in an electrochemical reactor. The reactor comprises an electrolyzer for oxidizing sulfuric acid to persulfuric acid. Persulfate production in an electrolytic cell is demonstrated in U.S. Pat. No. 4,144,144, which is incorporated by reference in its entirety. The reaction proceeds according to the equation:
2 H₂SO₄→H₂S₂O₈+H₂ (1).

The reaction is driven by the electrical current running through the electrolyzer, and is operated at a potential of about 4.5 volts. The persulfuric acid formed in the electrolyzer is hydrolyzed with water in a hydrolyzer. The reaction in the hydrolyzer is:
H₂S₂O₈+2 H₂O→2 H₂SO₄+H₂O₂ (2).

The product stream comprising sulfuric acid and hydrogen peroxide in water is then separated, and the sulfuric acid is recycled back to the electrolyzer. The electrolyzer is preferably operated at a temperature between about 20° C. and about 40° C.

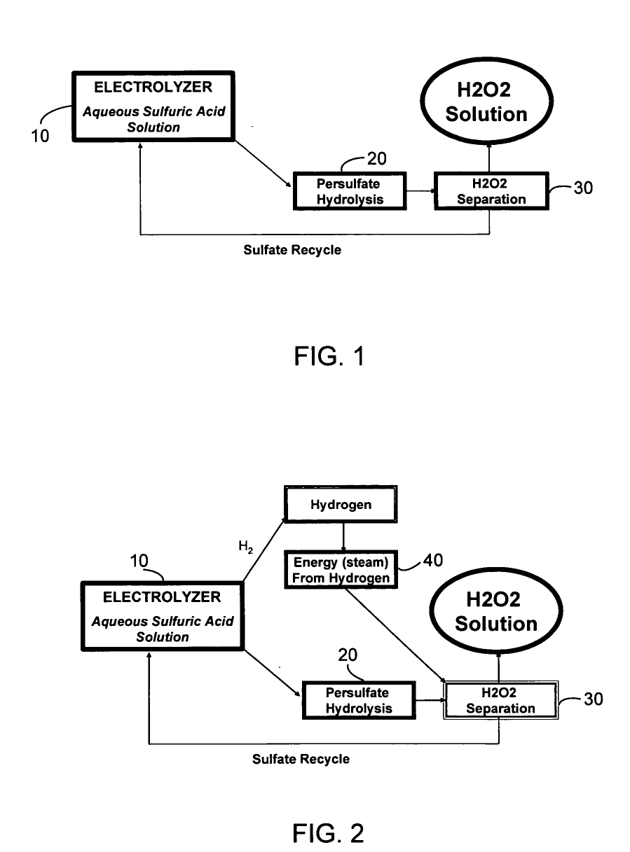

The process is shown in FIG. 1, wherein power is supplied to an electrolyzer 10. Water is added to the electrolyzer and the electrolyzer 10 comprises a solution of water and sulfuric acid, wherein the sulfate is oxidized to produce a solution comprising a persulfate. The solution comprising persulfate is drawn off from the electrolyzer 10 and passed to a hydrolyzer 20. Water is added to the hydrolyzer 20 with the persulfate solution, wherein the water is oxidized by the persulfate compound to form a solution comprising hydrogen peroxide and sulfuric acid. The solution comprising hydrogen peroxide is passed to a separator 30, wherein the hydrogen peroxide and sulfuric acid are separated. The sulfuric acid is recycled to the electrolyzer 10.

While one embodiment of the electrolyzer uses sulfuric acid, alternate embodiments can use other oxidizable compounds, such as for example chlorate compounds, inorganic sulfate salts, or a mixture of sulfate salts and sulfuric acid. Among the preferred inorganic sulfate salts, examples include, but are not limited to, sodium sulfate, potassium sulfate, and ammonium sulfate. Other inorganic chemicals that would be useful, are chemicals that form strong oxidizing agents when oxidized in an electrical environment such as in an electrolyzer.

There is a continuous feed of water to the electrolyzer to make up for water consumed in the process. During the operation of the electrolyzer, hydrogen in the form of a gas is generated. This hydrogen can be used to recover some of the energy that is used during the operation of the electrolyzer. One embodiment for using the hydrogen generated is to combust the hydrogen and form steam. The steam can be used as heat that is used in the process of separating the sulfate compound from the hydrogen peroxide. This embodiment is illustrated in FIG. 2, where an electrolyzer 10 oxidizes sulfuric acid to generate persulfuric acid. The persulfuric acid is drawn off and passed to a hydrolyzing reactor 20, where the persulfuric acid reacts with water to form a solution having hydrogen peroxide and sulfuric acid. The solution with hydrogen peroxide and sulfuric acid is passed to a separation unit 30, where a product stream comprising hydrogen peroxide is generated and a recycle stream comprising sulfuric acid is generated. The recycle stream is passed to the electrolyzer 10 to replenish the sulfate compound carried out to the hydrolyzing reactor 20. The electrolyzer is operated at a temperature between about 5° C. and about 50° C., with a preferred operation between about 10° C. and about 40° C.

A product of the oxidation of sulfuric acid is the production of hydrogen in the form of a gas. The hydrogen is passed to a combustion unit 40 which generates heat and steam. The energy produced by the combustion unit 40 can be used to heat the hydrolyzing reactor 20 for use with other units. In one embodiment, the hydrolyzer is operated between about 20° C. and about 90° C., with a preferred operation between about 40° C. and about 85° C., and a more preferred operation between about 60° C. and about 70° C. In another embodiment, the heat or steam or both can be passed to the separation unit 30, providing a portion of the energy required to drive the separation of hydrogen peroxide and sulfuric acid.

The hydrogen peroxide and sulfate compound are separated in a separation unit generating a first product stream comprising hydrogen peroxide, and a second product stream comprising the sulfate compound. The second product stream is also a recycle stream, wherein the recovered sulfate compound, in this instant invention sulfuric acid, is returned to the electrolyzer for continuing the process.

In one embodiment, the separation unit is a distillation unit. The distillation unit can be an ordinary distillation unit, a vacuum distillation unit, or a steam distillation unit. The choice of distillation unit will depend upon design and economic considerations. In the embodiment of a steam distillation unit, the hydrogen combustion unit can provide at least a portion of the steam used in the steam distillation separation. Distillation methods and operating conditions are well known in the art, and are not discussed here.

The current invention comprises the formation of hydrogen peroxide with the use of an acidic additive to drive the reaction. One of the problems to be solved is the separation of the additive for recycle. Acids are used as food acidulants in the pharmaceutical industry, and in industrial and detergent formulations. Currently, technology for the separation of organic acids involves salt precipitation by forming a calcium salt. The precipitated calcium salt is filtered and washed, and then reacidified with a strong acid, such as sulfuric acid, to regenerate the organic acid. Examples of organic acid separations are found in European Patent No. 135,728; United Kingdom Patent No. 868,926; and U.S. Pat. No. 4,323,702. These patents while presenting organic acid separation require the addition of additives, other than water, or use anion exchange resins that are not especially suited to this separation process.

In another embodiment, the separation unit comprises an adsorber. The adsorber may be a polymer based adsorption column, a reverse phase column, an ion exchange column, or an acid exchanged anion exchange column. This invention can be practiced as a fixed or moving bed adsorbent system, and can be run as either a batch or continuous process. It is preferred that the process be operated as a continuous process, and can be operated as a continuous countercurrent simulated moving bed system. One such system is described in U.S. Pat. No. 2,985,589, which is incorporated by reference in its entirety.

The acid exchange anion exchange column produces an adsorption system that preferentially adsorbs the acid. Therefore, a solution comprising an acid compound and hydrogen peroxide is passed over an adsorbent, and the adsorbent preferentially adsorbs the acid compound. In a particular embodiment, the acid compound is sulfuric acid, and the anion exchange resin is a polymeric adsorbent in sulfate form, wherein the adsorbent comprises a weakly basic anionic exchange resin having tertiary amine or pyridine functional groups, or the adsorbent comprises a strongly basic anionic exchange resin having quaternary amine functional groups, or the adsorbent comprises mixtures thereof. The ion exchange column is operated at a temperature between about 20° C. and about 100° C., and at a pressure between about 100 kPa (14 psia) and about 800 kPa (116 psia). It is preferable that the pH of the solution is lower than the first ionization constant, pKaᵢ, of the strong acid. This achieves high selectivity of the adsorbent for the adsorbed acid compound. A calculated separation capacity for the anion exchange column is about 85 g/liter resin of hydrogen peroxide, and about 17 g/liter resin of sulfuric acid.

Without being bound to any theory, it is believed that the sulfate compound is adsorbed on the anion exchange membrane through hydrogen bonding, thereby slowing the passage of the sulfate compound through the adsorber, and allowing the hydrogen peroxide to pass through more quickly, and generating a sulfate free hydrogen peroxide solution. Using water as the carrier of the solution facilitates desorption of the sulfate compound from the adsorbent during a backflush of the adsorber, or for use in a continuous process, such as with a simulated moving bed.

After the sulfate free hydrogen peroxide solution emerges through the outlet from the adsorption unit, the solution is passed to a collection vessel, or holding tank. The solution continues to be passed to the collection vessel until the sulfate compound begins to appear at the outlet of the adsorption unit. When the sulfate compound begins to appear from the adsorption unit, the solution is no longer passed to the collection vessel. The subsequent solution containing the sulfate compound is recycled back to the electrolyzer, or the method can begin reversing flow of desorbent through the adsorption unit. In a preferred operation, it is desired that the hydrogen peroxide solution be substantially free of the sulfate compound, while it is not required that the sulfate solution that is recycled to the electrolyzer be free of hydrogen peroxide. Therefore, the cutoff of the flow to the collection tank is determined based upon prevention of loss of the sulfate compound and not on the amount of hydrogen peroxide carried in the recycle stream back to the electrolyzer.

The adsorbed sulfate compound can be recovered by continuously running the adsorption column with a desorbent, such as for example water, or the column can be backwashed with a desorbent after the hydrogen peroxide has been removed from the column. Following separation, the sulfate compound is recycled to the electrolyzer.

In one embodiment, the apparatus includes a control system for turning the electrolyzer and separator on and off for a periodic, as-needed supply of hydrogen peroxide. This would be integrated with the entire control system for an appliance using an oxidizing compound.

In another embodiment, the separation unit is a precipitation unit, wherein the sulfate compound is reacted to form a precipitate and removed from solution. One specific example of an oxidizable compound is a sulfate compound and a specific sulfate compound is sulfuric acid, and is neutralized with a base wherein the neutralized acid forms a solid salt precipitate. The precipitate is separated from the liquid phase, and the hydrogen peroxide is recovered. The precipitate can be reconstituted, to regenerate the acid and recycle the acid to the electrolyzer.

In another embodiment, the separation unit is an air stripper. The air stripper comprises a vessel wherein the solution from the hydrolyzer is passed. The solution comprising hydrogen peroxide and sulfuric acid is aerated by passing air through a sparger, or other means to distribute the air in small bubbles in the solution. The hydrogen peroxide is preferentially carried out in the air with water vapor in a gas phase. The gas phase is then condensed to recover an aqueous solution comprising hydrogen peroxide.

Other embodiments include using a membrane separation unit wherein the membrane preferentially allows passage of one of the compounds in the process. Membrane separators are known in the art and described in U.S. Pat. No. 6,288,178 which is incorporated by reference in its entirety.

### EXAMPLE 1

Experiments were run for the hydrolysis of persulfate. The experiments were performed to test the use of hydrolyzing reactors for producing hydrogen peroxide. The glass reactor was heated to 60° C. with hot water, and when the temperature stabilized, 100 grams of persulfuric acid solution was added to the 100 ml capacity reactor and stirred. The system was closed and the reaction was allowed to proceed. The system included an inverted glass cylinder for collecting any gas generated during the reaction. Samples of the solution were taken initially, and at intervals of 30 minutes for up to 2 hours. The samples were then analyzed for hydrogen peroxide concentration and for persulfuric acid concentration.

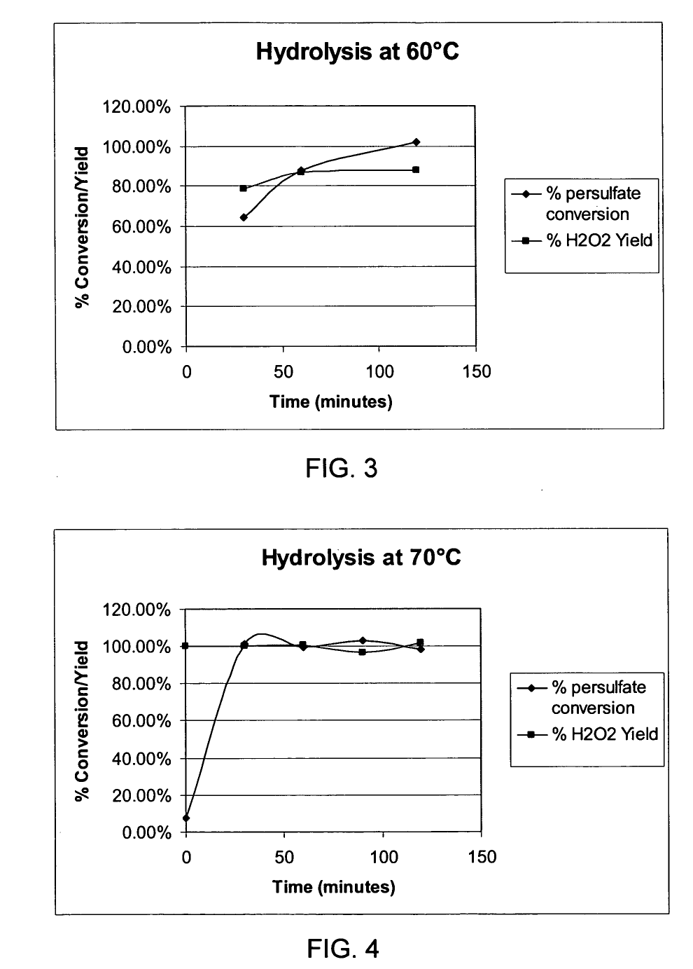

FIGS. 3 and 4 show the results of hydrolysis of persulfuric acid in the production of hydrogen peroxide, for reactors operated at 60° C. and 70° C. respectively. The persulfuric acid oxidized water to form hydrogen peroxide. The results show the persulfate rapidly reacts with the water, with about 100% conversion of the persulfuric acid to sulfuric acid over the course of approximately 2 hours. The percentage yield of hydrogen peroxide is the amount of hydrogen peroxide produced relative to the amount of persulfate reacted. The results indicate that the reaction proceeds almost to completion and that one can expect greater than 80% of the expected amount of hydrogen peroxide from the reaction. From the experimental results, the operating temperatures for the hydrolyzing reactors is preferably between about 40° C. and about 85° C.

### EXAMPLE 2

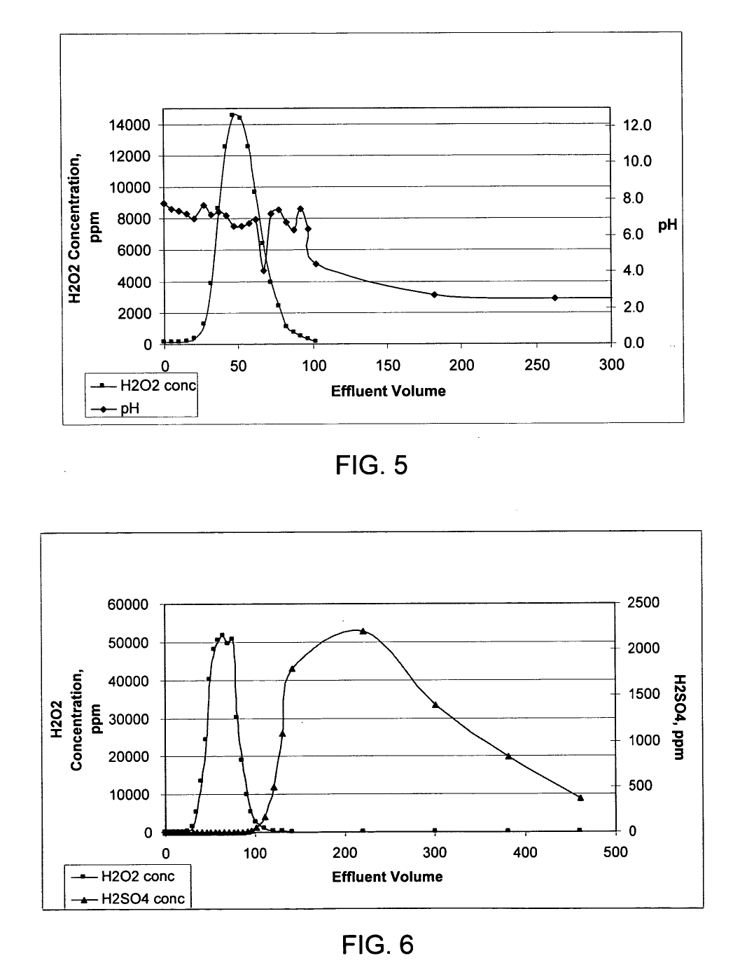

After the production of hydrogen peroxide, a solution comprising hydrogen peroxide and sulfuric acid is generated. The solution needs to be separated and a product stream comprising hydrogen peroxide, and a recycle stream comprising the acid are needed. An anion exchange resin was used for separation of the sulfuric acid and hydrogen peroxide. A commercially available anion exchange resin was used, AMBERLITE™ IRA-400 from Rohm & Haas, Philadelphia, Pa. The resin was acid saturated with sulfuric acid and loaded into an ion exchange column, forming a bed volume of 20 cc. The column was washed to a pH neutral condition, and then solutions of sulfuric acid and hydrogen peroxide were injected. The column was operated at room temperature and atmospheric pressure. The solutions comprised 5% H₂O₂ and 1% H₂SO₄, and were injected in amounts of about 34 cc. In one run, as shown in FIG. 5, the hydrogen peroxide concentration peaks and declines, followed by the pH beginning to decline, indicating the hydrogen peroxide passed through the column before the sulfuric acid began to exit the column. The recovery for both hydrogen peroxide and sulfuric acid were calculated at about 100%.

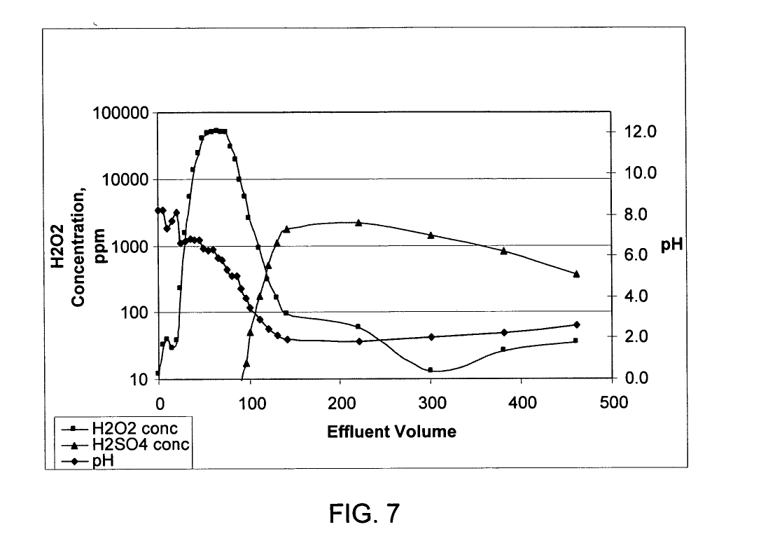

A second test example is shown in FIGS. 6 and 7 demonstrating the separation of the hydrogen peroxide and sulfuric acid, and that an ion exchange resin such as AMBERLITE IRA-400 provides for a good separation of the hydrogen peroxide and sulfuric acid. The data indicates that one can recover most of the hydrogen peroxide with almost no sulfuric acid, and that the sulfuric acid can be substantially entirely recycled.

### EXAMPLE 3

The separation of hydrogen peroxide and sulfuric acid is needed to produce an acid free hydrogen peroxide solution. In this example an alternate method of separating the compounds was tested. A solution comprising 5 wt. % hydrogen peroxide and 20 wt. % sulfuric acid was obtained. 100 grams of the solution was loaded into a vessel having a 500 cc volume. The vessel was heated, and air was passed through the solution and generated a vapor stream comprising water and hydrogen peroxide. The vapor stream was condensed in a condenser which was cooled to a temperature between about 0° C. and about 20° C. The cooled vapor stream was then passed through water in a container at temperature between about 0° C. and about 20° C. to dissolve any residual hydrogen peroxide in the cooled vapor.

The results for the separation of hydrogen peroxide and sulfuric acid by air stripping are shown in Table 1.

TABLE 1

| | | | | | | H2SO4 | Material | |
|---|---|---|---|---|---|---|---|---|
| | | | | H2O2 | | Conc. In | Balance | |
| | | Air Flow | Time | conc., | H2O2 | Adsorber | for | Decomposed |
| Run # | Temperature | (liters/min) | (hours) | wppm | Recovery | wppm | H₂O₂ | H₂O₂ |
| 1 | 60 | 20.8 | 4 | 9848 | 70.24% | 5.15 | 0.87 | 13.37% |
| 2 | 80 | 15 | 3 | 21,010 | 81.36% | 923 | 0.81 | 18.62% |
| 3 | 80 | 24.5 | 3 | 17,766 | 80.85% | 251 | 0.81 | 18.95% |

All of the runs passed through glass wool in the gas phase. It was found that air separation generates a relatively high recovery of hydrogen peroxide with a greater than 99% removal of the sulfuric acid from the hydrogen peroxide.

While the invention has been described with what are presently considered the preferred embodiments, it is to be understood that the invention is not limited to the disclosed embodiments, but it is intended to cover various modifications and equivalent arrangements included within the scope of the appended claims.

What is claimed is:

1. A method of generating an oxidizing compound comprising:
oxidizing an oxidizable compound to form an oxidizing agent in an electrolyzer and generating a stream comprising the oxidizing agent;
hydrolyzing the oxidizing agent with water to generate a solution comprising the oxidizing compound and the oxidizable compound;
separating the oxidizing compound and oxidizable compound to form a first stream comprising the oxidizing compound and a second stream comprising oxidizable compound; and
recycling the oxidizable compound to the electrolyzer.

2. The method of claim 1 wherein the oxidizable compound is selected from the group consisting of chlorate compounds, sulfuric acid, inorganic sulfate salts, and mixtures thereof.

3. The method of claim 1 wherein the oxidizing agent is selected from the group consisting of perchlorate compounds, persulfuric acid, inorganic persulfate salts, and mixtures thereof.

4. The method of claim 1 wherein the oxidizing compound is selected from the group consisting of hydrogen peroxide, perhydroxyl ion, perhydroxyl radical, hydroxyl radical, peroxide ion, and mixtures thereof.

5. The method of claim 1 further comprising:
generating a hydrogen rich gas in the electrolyzer; and
combusting the hydrogen rich gas to generate steam.

6. The method of claim 1 wherein the electrolyzer is operated at a temperature between about 10° C. and about 40° C.

7. The method of claim 1 wherein the hydrolyzer is operated at a temperature between about 20° C. and about 90° C.

8. The method of claim 7 wherein the hydrolyzer is operated at a temperature between about 40° C. and about 85° C.

9. The method of claim 1 wherein the separation step comprises distillation.

10. The method of claim 1 wherein the separation step comprises passing the solution comprising the oxidizing agent and the oxidizable compound through an adsorber.

11. The method of claim 10 wherein the adsorber preferentially weakly adsorbs and desorbs the oxidizable compound.

12. The method of claim 1 wherein the separation step comprises passing the solution comprising the oxidizing compound and the oxidizable compound through an ion exchange column.

13. The method of claim 1 wherein the separation step comprises stripping the oxidizing compound from the solution comprising the oxidizing compound and the oxidizable compound by passing air through the solution and generating a gas stream comprising the oxidizing compound.

14. The method of claim 13 further comprising passing the gas stream comprising the oxidizing compound through water.

15. A hydrogen peroxide generator comprising:
an electrolyzer for generating an oxidizing agent stream having an inlet and an outlet for the generated oxidizing agent stream;
a hydrolyzer for hydrolyzing the oxidizing agent with water to generate a hydrolyzer stream comprising hydrogen peroxide and an oxidizable compound, and having an inlet in fluid communication with the electrolyzer outlet and an outlet for the hydrolyzer stream; and
a separator for separating the hydrogen peroxide and the oxidizable compound, and having an inlet in fluid communication with the hydrolyzer outlet and an outlet for a stream comprising hydrogen peroxide and an outlet for a stream comprising the oxidizable compound.

16. The reactor of claim 15 wherein the oxidizing agent is selected from the group consisting of persulfuric acid, inorganic persulfate salts, inorganic perchlorate compounds, and mixtures thereof.

17. The reactor of claim 15 wherein the oxidizable compound is selected from the group consisting of sulfuric acid, inorganic sulfate salts, inorganic chlorate compounds, and mixtures thereof.

18. The reactor of claim 15 wherein the separator is an adsorber that preferentially adsorbs the oxidizable compound.

19. The reactor of claim 18 wherein the adsorber includes a polymeric adsorbent in sulfate form.

20. The reactor of claim 15 further comprising a hydrogen combustion unit.

21. The reactor of claim 15 wherein the separator comprises an air stripping unit.

22. The reactor of claim 21 further comprising a unit for dissolving the hydrogen peroxide in water and having an inlet in fluid communication with the air stripping outlet.

23. The reactor of claim 15 wherein the separator comprises a distillation unit.

24. The reactor of claim 15 wherein the separator is a membrane separation unit.

25. An apparatus for generating an oxidizing compound in an appliance comprising:
an electrolyzer with an inlet for admitting water, an inlet for admitting a stream comprising an oxidizable compound, and an outlet for an electrolyzer stream comprising the oxidizing compound;
a separator with an inlet in fluid communication with the electrolyzer outlet, a product outlet for a product stream comprising the oxidizing compound, and a recycle outlet for a recycle stream comprising the oxidizable compound; and
a storage compartment for periodically holding the oxidizing compound with an inlet in fluid communication with the separator product outlet.

26. The apparatus of claim 25 wherein the oxidizing compound is selected from the group consisting of hydrogen peroxide, perhydroxyl ion, perhydroxyl radical, hydroxyl radical, peroxide ion, and mixtures thereof.

27. The apparatus of claim 25 wherein the oxidizable compound is selected from the group consisting of sulfuric acid, inorganic sulfate salts, inorganic chlorate compounds, and mixtures thereof.

28. The apparatus of claim 25 wherein the appliance is selected from the group consisting of washing machines, dryers, dishwashers, spas, pools, hot tubs, faucets, garbage disposals, air conditioners, refrigerators, freezers, humidifiers, dehumidifiers, toilets, urinals, bidets, agricultural equipment, sanitizers, and food processing equipment.

29. The apparatus of claim 25 wherein the electrolyzer includes an air inlet port and at least one outlet port for gases generated.

30. The apparatus of claim 25 further comprising a reactor having an inlet in fluid communication with the electrolyzer outlet, and an outlet in fluid communication with the separator inlet.

31. The apparatus of claim 30 wherein the reactor is a hydrolyzing unit.

32. The apparatus of claim 25 wherein the separator is an adsorber.

33. The apparatus of claim 32 wherein the adsorber includes a backwash system.

34. The apparatus of claim 25 wherein the separator is an air stripping unit.

35. The apparatus of claim 25 wherein the separator is a distillation unit.

36. The apparatus of claim 25 wherein the separator is a membrane separation unit.

37. The apparatus of claim 25 wherein the storage compartment includes a control system for turning the electrolyzer on and off.

38. The apparatus of claim 25 further comprising a condensation unit having an inlet in fluid communication with the product outlet of the separator.
